(19) United States
(12) Patent Application Publication
(10) Pub. No.: US 2022/0250947 A1
(43) Pub. Date: Aug. 11, 2022

(54) WATER TREATMENT METHOD TO GENERATE FERTILIZATION OR FERTIGATION PRODUCT

(71) Applicant: Agua DB Ltd, Bisley, Gloucestershire (GB)

(72) Inventor: Michael John Waite, Bisley, Gloucestershire (GB)

(73) Assignee: Agua DB Ltd, Bisley, Gloucestershire (GB)

(21) Appl. No.: 17/608,421

(22) PCT Filed: Mar. 27, 2020
(86) PCT No.: PCT/GB2020/050829

§ 371 Date: Nov. 2, 2021

(30) Foreign Application Priority Data
May 3, 2019 (GB) 1906278.5

(51) Int. Cl. C02F 1/42; B01J 41/05; B01J 41/12; B01J 39/08; B01J 47/028; B01J 49/57; B01J 49/53; B01J 49/60; B01J 49/08; C05D 1/02; C05C 5/02; C05G 1/00; C05D 3/00; C02F 1/66; C02F 1/44

(52) U.S. Cl. CPC C02F 1/42; C02F 2101/163; B01J 41/12; B01J 39/08; B01J 47/028; B01J 49/57; B01J 49/53; B01J 49/60; B01J 49/08; C05D 1/02; C05C 5/02; C05G 1/00; C05D 3/00; C02F 1/66; C02F 1/441; C02F 1/442; C02F 2001/422; C02F 2303/16; B01J 41/05

(57) ABSTRACT

A water treatment method to generate potable water and a fertilization or fertigation product is provided. The method comprises the steps of: passing a raw water stream through an anion exchange resin (14a, 14b) to generate a potable water output; regenerating the anion exchange resin (14a, 14b) using a weak potassium chloride solution to generate a product output comprising potassium sulphate, potassium bicarbonate, and preferably also potassium nitrate, suitable for use as or as a precursor to a liquid fertilization or fertigation product.

### CROSS-REFERENCE TO RELATED APPLICATIONS

This application is a national phase entry under 35 U.S.C. § 371 of International Application PCT/GB2020/050829, filed Mar. 27, 2020, which claims priority to GB Patent Application No. 1906278.5, filed May 3, 2019, all of which are herein incorporated by reference in their entirety.

### TECHNICAL FIELD

The present invention relates to a water treatment method to generate potable water and a fertilization or fertigation product, particularly but not necessarily exclusively potassium sulphate-based fertilization or fertigation products and optionally also a mixture of potassium nitrate and potassium chloride. The invention further relates to a water treatment plant suited to carrying out the method, and to an alternative filtration-based water treatment method.

### BACKGROUND

Nitrate contamination in drinking water is a major global concern, and typically occurs from industrial effluent and fertilizer run-off from agricultural practices. Historically, nitrate contamination has been attributed to farming activities mainly through the development of cheap fertilizers in the 1950's leading to overuse, resulting in significant nitrate run-off. Animal waste is also a contributing factor. Nitrate contamination levels are consistently higher in areas of high agricultural activity. Fertigation, that is, the application of fertilizer in liquid solution, is acknowledged as best practice for fertilizer addition due to the efficiency of both water and fertilizer along with minimal run-off and environmental impact. Fertigation is therefore being utilised on an increasing basis, particularly in areas with water supply problems; Israel has a fertigation take-up rate of 50%, compared with just 5% take-up in the UK versus solid fertilizer.

The two most common methods of reducing nitrate levels in drinking water are ion exchange and reverse osmosis, with ion exchange being regarded as the superior technology due to the lower waste volumes produced.

Research over the past thirty years has focussed on improving ion exchange resins to preferentially remove nitrate rather than sulphate, leasing to the introduction of nitrate-selective resins, and also to ion exchange process improvements, including the introduction of multiple small column systems, which minimise the ion exchange resin inventory in the plant. Such configurations offer lower waste volumes than conventional ion exchange plants, and more recently, to improved regeneration processes which can lead to further waste volume reductions.

However, water requiring nitrate treatment is still comparatively expensive, and nitrate treatment requires capital expenditure on plant along with operational costs for servicing and consumables. In the UK, the industry is structed into a small number of large water companies who are able to build an operate plant, since the costs can be spread across a large consumer base. The water produced remains expensive compared to other sources, and therefore the plants are only operational where alternative water sources are not available. This leads to reliability issues with plants that are infrequently operational, and therefore to a general and widespread belief that nitrate plants are both expensive and unreliable.

In the US, the situation is very different. There are many small water companies servicing local communities, often with fewer than 50 connections. Such companies have no internal expertise or experience to manage capital plant constructions, and the servicing costs would be prohibitively expensive were the plant to be servicing by an experienced engineer on a monthly basis, for instance. This could, in effect, lead to a doubling in the cost of the water expenditure for the community, which is unlikely to be sustainable in what are typically poorer communities. When the additional operational consumable costs for salt and waste disposal are considered, which may be ten-fold greater than routine maintenance charges, the conventional approach to nitrate treatment is clearly unviable. It is to be noted that in many communities, such as in those in Central Valley, California where many studies have been conducted, excessive nitrate levels have been identified for many years, in excess of 10 mg/l, without the implementation of any nitrate treatment facilities.

In an effort to mitigate the consumable cost for nitrate-selective ion exchange, common salt, that is, sodium chloride, has been the preferred regenerant of choice for nitrate treatment due to its availability and low cost. This, however, creates a wide variety of sodium-based waste products, such as sodium nitrate, sodium sulphate, and sodium bicarbonate, along with lesser amounts of other ions and trace metals and organics. This waste must be transported to a disposal site or sewerage treatment works with sufficient capacity to process it.

Potassium chloride has previously been postulated as an alternative regenerant, but it is much more expensive, and therefore is not used in favour of sodium chloride. Furthermore, the solubility of potassium sulphate is limited, and a conventional regeneration using just a strong potassium chloride solution would lead to the level of potassium sulphate exceeding the limit of solubility, and precipitating into the resin bed. This would potentially damage the ion exchange resin and would not facilitate the separation of the sulphate from the chloride nitrate stream.

The present invention seeks to provide an improved ion exchange regeneration process which mitigates the cost of nitrate reduction ion exchange processes by producing a commercially viable by-product. This also has the advantage of reducing the cost of waste removal, and potentially also monetizing the by-product so that nitrate removal can be performed in a cost- and environmentally-neutral manner. The potential for direct local re-use favours the use of this technology particularly at remote rural sites.

### SUMMARY

According to a first aspect of the invention, there is provided a water treatment method to generate potable water and a fertilization or fertigation product, the water treatment method comprising the steps of: a] passing a raw water stream through an anion exchange resin to generate a potable water output; b] regenerating the anion exchange resin using a weak potassium chloride solution to generate a product output comprising potassium sulphate and potassium bicarbonate suitable for use as or as a precursor to a liquid fertilization or fertigation product.

Ion exchange water treatment plants are expensive and create large amounts of unusable waste product. By careful regeneration of anion exchange columns, however, it becomes possible to separate out many of the waste products into usable forms, particularly for agricultural use, and thereby recouping much of the cost associated with the construction and maintenance of the plant. Not only can the products be sold at a higher value than the consumables, typically for use locally in an environmentally-sustainable manner, but significantly fewer waste products are generated.

Preferably, during step b], the weak potassium chloride solution may be a 0.02M to 0.5M potassium chloride solution. In a preferred embodiment, 3 to 6 bed volumes of the potassium chloride solution may be passed through the anion exchange resin at a flow rate of 1 to 4 bed volumes per hour.

A dilute potassium chloride solution has the advantage or preferentially removing sulphates and bicarbonates from the ion exchange resin without releasing significant amounts of the captured nitrate. This allows for sulphate-specific extraction. A weaker potassium chloride solution may be required for a nitrate-selective resin than for a strong base anion resin.

The method may further comprise a step b](i) subsequent to step b] of: regenerating the anion exchange resin using a strong potassium chloride solution to generate a further product output comprising a mixture of potassium nitrate and potassium chloride.

The potassium nitrate and potassium chloride elution is not without agricultural uses, containing both nitrogen and potassium in a single solution. Potassium chloride is conventionally applied as potash and the product is superior to potash in that a proportion of the chloride ions have been replaced with nitrate ions through the regeneration process. As such, it is beneficial for the user to find a suitable practical use for this elution as a direct replacement for potash to not only reduce waste, but also to increase commercially-viable product yield.

Optionally, during step b](i), the strong potassium chloride solution may be a 1.5M to 3.0M potassium chloride solution. In a preferred embodiment, 3 to 6 bed volumes of the potassium chloride solution may be passed through the anion exchange resin at a flow rate of 1 to 4 bed volumes per hour.

The regeneration of the ion exchange resin is required to perform continuous water treatment, and therefore the nitrate ions do need to be regularly removed in this two-stage process to avoid significant decreases in plant efficiency.

The method may further comprise a step b](ii) subsequent to step b](i) of separating the potassium nitrate from residual potassium chloride.

Potassium chloride is useful from an agricultural perspective as it is applied as a solid, potash, and is one of the major sources of potassium fertilizer. If the potassium nitrate and chloride were to be separated in the second elution so that the potassium chloride can be recycled back to the salt saturator and a second potassium nitrate product obtained. However, subsequent processing to achieve this separation may not be cost effective. Preferably, the separation of the potassium nitrate and potassium chloride may be achieved by any one of or a combination of: eutectic freeze crystallization; evaporation; and assisted evaporation.

By providing a means of separating the potassium nitrate and potassium chloride from one another, potassium nitrate, can be commercialised separately of the potassium chloride.

The method may further comprise a step b](iii), subsequent to step b] of rinsing the anion exchange resin using softened water at a flow rate of 1 to 4 bed volumes per hour.

A final rinse of the anion exchange resin ensures that any residual ions are removed from the bed prior to re-use of the resin.

Preferably, the method may further comprise the steps of: c] combining the product output with an acid in a treatment vessel to reduce the pH of the product output to between 2 and 4 to remove the potassium bicarbonate; and d] combining the product output with a base in a or the treatment vessel to increase the pH of the product output to approximately 5.5 to 7, to create a liquid fertilization or fertigation product comprising potassium sulphate.

By driving off the bicarbonate, the more valuable potassium sulphate can be recovered for an excellent fertilization or fertigation product.

Optionally, during step c], the acid is any one of sulphuric acid, nitric acid, and phosphoric acid, to respectively convert the potassium bicarbonate to potassium sulphate, potassium nitrate, or potassium phosphate.

The advantage of using stronger acids, such as those defined above, is that the resultant salts are useful fertilizer compounds, whereas a cheaper acid, such as hydrochloric acid, would result in additional waste products without agricultural utility. As such, the increased cost of the stronger acids can yield profitable benefits.

Optionally, during step d], the base may be potassium hydroxide.

It is preferred that the base be potassium hydroxide, since the use of the cheaper sodium hydroxide could result in an inferior fertilization or fertigation product.

In a preferred optional embodiment of the invention, during step b], a base may be added to the weak potassium chloride solution to increase the pH to between 8 and 10, to inhibit elution of arsenic in the As(iii) oxidation state.

Arsenic contamination of the fertilization or fertigation product output is to be avoided. Arsenic is toxic and therefore should be kept out of the food chain. By pH modifying the regenerant, it becomes possible to prevent unintentional elution of the arsenic in its As(iii) oxidation state, preserving the integrity of the product output. Not only does the increase in the pH inhibit elution of As(iii), it also has the advantage of preventing vanadium in the V(iii) oxidation state from dropping out as a gelatinous precipitate, which is only slowly removed through the regeneration process.

Preferably, during step a], a lead-lag anion exchange resin system or a merry-go-round anion exchange resin system may be provided.

Either of these arrangements allows for near continuous water treatment, since a fully anion loaded ion exchange column can be regenerated whilst the other anion exchange column continues to perform ion exchange. This rotation can be performed sequentially, so that no excessive down time for the plant is provided.

During step a], the anion exchange resin may be a nitrate-selective anion exchange resin or a strong base anion resin.

The present invention is particularly directed towards the extraction of nitrates from water, which can appear in high concentrations in isolated agricultural communities which are often those in most need of clean potable water. The use of nitrate-selective resins also provides suitable nitrate salts which can be used in fertilization and fertigation products. If there is a need to reduce the arsenic levels in the product water, the use of strong base anion resins over nitrate-selective resins would be preferred, as arsenic will continue to be absorbed onto the resin even when nitrate breakthrough in the resin bed occurs. Arsenic breaks through before nitrate does when nitrate-selective resins are used, meaning that some of the previously absorbed arsenic could be released into the product water. This is undesirable.

Optionally, during step a], the raw water stream and/or potable water output may be passed through a cation exchange column to remove calcium and/or magnesium. The method may preferably further comprise a step a](i), subsequent to step a] of regenerating the cation exchange column to generate a calmag output solution comprising calcium and/or magnesium, and, during step d], introducing at least a portion of the calmag output solution into the liquid fertilization or fertigation product.

This cation exchange column contains approximately 20% of the volume of ion exchange resin compared to the anion ion exchange columns and would normally process sufficient water to generate soft water for chemical make-up. This column would be regenerated by diverting the final fraction of the strong regenerant and then the rinse through the cation exchange column. However, calcium and magnesium are required for healthy plant growth and are often present in complete fertigation products available commercially. The operation of the plant can be set up to provide additional calcium and magnesium by processing raw or product water through the cation exchange column such that the quantity of calcium and magnesium removed matches the required quantity in the product. Preferably, during step a](i), a potassium chloride solution may be used as the regenerant, and more preferably, the potassium chloride solution may be the elution from step b](ii).

Potassium chloride has many advantages as regenerant, since it is readily recycled through the treatment process, thereby minimising waste. The ability to use a previous potassium chloride solution from the anion exchange regeneration also reduces consumable costs. As the strong potassium chloride regeneration of the anion exchange column proceeds, the bottom of the potassium chloride feed tank is reached, and a softened water rinse is applied. At the same time, the cation exchange column is valved into the regenerant out line for the anion exchange column. The anion exchange column includes approximately 0.5 bed volumes of strong potassium chloride solution with a small amount of nitrate therein, but no sulphate content. As such, it is ideal for regeneration of the cation exchange column, and no sulphate precipitation occurs. All of the calcium and magnesium then ends up in the further product output.

There may be a step, prior to step a], in which the cation exchange column is pre-loaded with additional calcium and/or magnesium in order to provide a correct concentration of calcium and/or magnesium for the liquid fertilization or fertigation product.

Since the cation content of the raw water may not have sufficient levels of calcium or magnesium, pre-doping of the cation exchange column may provide user selectability of the composition of the product output.

The method may further comprise the step of adding complementary fertilization compounds to the product output to produce a desired fertilization or fertigation product.

By adding complementary compounds, such as nitrogen and phosphorus compounds, a complete fertilization or fertigation product may be obtained.

As an alternative, the method may further comprise the step of filtering the product output using a nanofilter to separate the potassium bicarbonate and potassium sulphate.

A filtration system provides a non-chemical means of separating out the potassium bicarbonate, as opposed to the acidic removal of the bicarbonate.

The method may optionally comprise a step subsequent to the filtration step of generating a fungicide product using the potassium bicarbonate product output.

Since the bicarbonate has been separated, rather than chemically disposed of, in this arrangement, it can be used as an additional product of agricultural value. Potassium bicarbonate has fungicidal uses, and this output can assist with this.

According to a second aspect of the invention, there is provided a water treatment plant comprising: a raw water input; at least one anion exchange resin having an inlet and an outlet, the raw water input being in fluid communication with the inlet of the or each anion exchange resin; a regenerant line in fluid communication with the inlet of the or each anion exchange resin; a potable water conduit in fluid communication with the outlet of the or each ion exchange resin; a product output treatment vessel in fluid communication with the outlet of the or each anion exchange resin for receiving the output of a second ion-exchange regeneration effluent; a further output vessel in fluid communication with the outlet of the or each anion exchange resin for receiving the output of a second ion-exchange regeneration effluent; a controller for selectively controlling the fluid flow from the outlet of the or each anion exchange resin; and a dispenser associated with the product output treatment vessel for dispensing a liquid fertilization or fertigation product generated therein.

A treatment plant which is configured to dispense the fertilization or fertigation product at the point of water treatment may be of significant value, particularly to agricultural communities where there is both a large fertigation requirement and relatively low population which would otherwise find the cost of a water treatment plant to be prohibitive.

The water treatment plant may further comprise a cation exchange column having an inlet and an outlet, the inlet being in fluid communication with at least one of the raw water input and the potable water conduit, and the outlet being in communication with at least one of the product output treatment vessel and the further output vessel.

The cation exchange column can both improve the fertilization or fertigation product, whilst also potentially reducing waste disposal and consumable costs.

### BRIEF DESCRIPTION OF THE DRAWINGS

The invention will now be more particularly described, by way of example only, with reference to the accompanying drawings, in which:

FIG. 1 shows a diagrammatic representation of one embodiment of a water treatment plant in accordance with the second aspect of the invention, and which is configured for use in a method in accordance with the first aspect of the invention;

FIG. 2 shows a graphical representation of an elution profile from the regeneration of anion exchange resins according to one embodiment of a method in accordance with the first aspect of the invention, indicating the bicarbonate, chloride, sulphate, and nitrate peaks;

FIG. 3 shows an enlarged view of the elution profile of FIG. 2 over the first three bed volumes of regenerant;

FIG. 4 shows a graphical representation of an elution profile from the regeneration of the anion exchange resin as per FIG. 2, indicating the arsenic and vanadium peaks; and

FIG. 5 shows a graphical representation of an elution profile from the regeneration of the anion exchange resin as per FIG. 2 without the regenerant having been pH-treated, indicating the arsenic and vanadium peaks.

### DETAILED DESCRIPTION

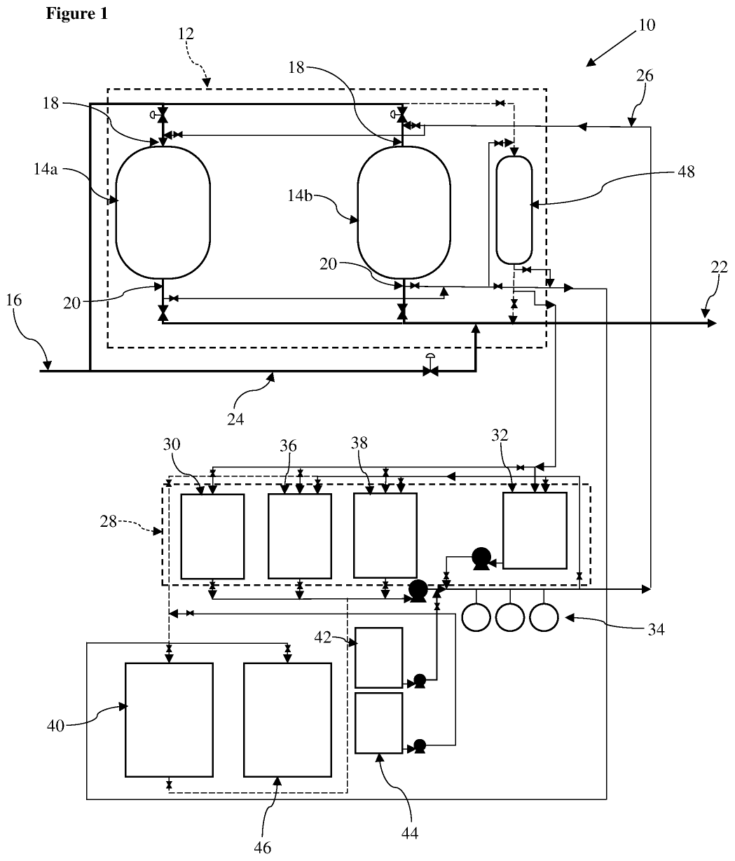

Referring to FIG. 1, there is indicated a water treatment plant, indicated globally at 10, which is suitable for extracting a liquid fertilizer product from the waste from ion exchange whilst treating raw water.

The water treatment plant 10 comprises a plurality of different modules, in order to allow a plant to be assembled according to the user's needs and the output requirements.

Water treatment is performed by ion exchange, and in this instance, there is at least one, and preferably a plurality of ion exchange resins as part of an ion exchange module 12. The depicted water treatment plant 10 preferably includes a first anion exchange resin 14a, and a second anion exchange resin 14b, here shown in the form of ion exchange columns or similar vessels, which may be configured in parallel configuration, sometimes known as a merry-go-round system, as illustrated, or alternatively in a lead-lag arrangement.

In a parallel configuration, raw water flows through both anion exchange resins 14a, 14b and the flow through each column is adjusted such that the columns are loading out of phase with one another. As such regeneration will not be required simultaneously. When one anion exchange resin 14a, 14b has been regenerated, it is just put back into service with the other. When the other anion exchange resin 14a, 14b is fully loaded, it can then be regenerated instead.

In a lead-lag configuration, the raw water is passed through the first anion exchange resin 14a, and then into the second anion exchange resin 14b. When the first anion exchange resin 14a is loaded, it can be disconnected, and flow can pass solely through the second anion exchange resin 14b whilst the first anion exchange resin 14a is regenerated. Once the regeneration is complete, the flow output from the second anion exchange resin 14b can be diverted through the first anion exchange resin 14a, that is, in a reversal of the original flow. Once the second anion exchange resin 14b is loaded, it can then be disconnected, and flow passed solely through the first anion exchange resin 14a whilst the second anion exchange resin 14b is regenerated. This allows for continuous cyclical water treatment without needing plant 10 shutdown during regeneration periods.

In the present arrangement, the first and second anion exchange resins 14a, 14b are loaded with a nitrate-selective resin, which preferentially captures nitrate ions from the water.

Other anions will also be captured, but the primary aim of a nitrate-selective resin is to reduce nitrate concentration within a water supply to safe levels. Strong base anion resins may also capture nitrates preferentially to certain anions, and may also be viable within the present configuration. Examples of suitable resins are A520e and A600/9149 supplied by Purolite®.

A raw water inlet 16 is connected to the inlets 18 of the anion exchange resins 14a, 14b and a controller, preferably a single electronic and/or automatic controller, is configured to be able to switch the flow between the respective lead and lag anion exchange resins 14a, 14b accordingly.

The raw water is passed through the anion exchange resins 14a, 14b, and ion exchange occurs to remove nitrate ions from the water by exchange with, typically, chloride ions. Potable water with safe nitrate concentrations is then output from at least one of the outlets 20 of the anion exchange resins 14a, 14b, and into a potable water conduit 22. A plant bypass line 24 is also illustrated, which allows a proportion of water to be treated and blended with untreated water to reduce the nitrate level in the product water to the required level.

This is the basic water treatment process. As ion exchange occurs, the anion exchange resins 14a, 14b will become loaded with nitrate ions, and treatment efficiency will drop. The nitrate concentration of the potable water can therefore be monitored using a nitrate-ion sensor in order to determine whether the anion exchange resins 14a, 14b require regeneration.

A regenerant line 26 selectively feeds into the inlets 18 of the anion exchange resins 14a, 14b, and supplies regenerant thereto. This may be connected to a regeneration module 28. The regeneration module 28 preferably includes a softened water reservoir 30, at least one potassium chloride solution reservoir, and a salt saturator 32, which in combination are able to generate the various solutions required as part of the regeneration procedure. The status of the regenerant can be monitored via one or more sensors 34, such as pH, conductivity or flow sensors.

First and second potassium chloride reservoirs 36, 38 may be provided, respectively for making up dilute and strong potassium chloride solutions. Softened water from the softened water reservoir 30 can be percolated through the salt saturator 32, typically containing solid pellets or granules of potassium chloride. A saturated potassium chloride solution can be retrieved from the salt saturator 32, and directed into the first and second potassium chloride reservoirs 36, 38. The concentration of the solution can then be corrected by introduction of softened water from the softened water reservoir 30.

To regenerate the anion exchange resins 14a, 14b, a first potassium chloride solution is applied to the columns. A preferred first fraction would comprise 3 to 6 bed volumes of 0.02M to 0.5M potassium chloride solution in softened water, for example, from the first potassium chloride reservoir 36, passed through the anion exchange resins 14a, 14b at a flow rate of 1 to 4 bed volumes per hour.

This dilute fraction has the advantage of releasing many of the non-nitrate contaminants which have been captured by the anion exchange resins 14a, 14b in preference to nitrate release, and allows the contaminants to be separated in a useful manner. In particular, this first fraction releases high concentrations of potassium sulphate and potassium bicarbonate.

A second fraction is then provided as a regenerant, which is a stronger potassium chloride solution. A preferred second fraction would comprise 3 to 6 bed volumes of 2M to 3M potassium chloride solution in softened water, preferably from the second potassium chloride reservoir 38 passed through the anion exchange resins 14a, 14b at a flow rate of 1 to 4 bed volumes per hour.

Finally, the regeneration process is completed by rinsing the anion exchange resins 14a, 14b with softened water at a flow rate of 1 to 4 bed volumes per hour, until the effluent water has a conductivity of less than 2,000 μScm⁻¹, which is indicative of a low flux of ions in the water.

The waste from the regeneration process can be collected according to the expected contents thereof. In particular, the regenerant waste from the first fraction forms a product output comprising potassium sulphate and potassium bicarbonate which can be transferred from the outlet 20 of the anion exchange resins 14a, 14b into a product output treatment vessel 40. The controller is preferably configured to activate the switching of the flow through the water treatment plant 10 to ensure that only the effluent of the first fraction enters into the product output treatment vessel 40, and that other effluents are diverted elsewhere.

The solution in the product output treatment vessel 40 therefore comprises potassium bicarbonate and potassium sulphate. Potassium sulphate is an excellent fertilizer, since it is a source of both potassium and sulphur for crops, without increasing the chloride content of the soil, which can be deleterious for many crops. This is particularly important for, for instance, tobacco and some fruit and vegetables. Potassium sulphate is particularly important during periods of fruit ripening.

Potassium bicarbonate has fewer uses, though in isolation, it can be utilised as a fungicide. However, for the purposes of producing a fertilization or fertigation, it is preferred that the potassium bicarbonate be removed from the potassium sulphate in order to make most effective use of the potassium sulphate. It is not essential, however, that the potassium sulphate and bicarbonate be separated; indeed, a suitable fertilization or fertigation product can still be created.

To remove the potassium bicarbonate from the product output treatment vessel 40, it is possible to alter the pH of the solution. Initially, this can be performed by the provision of an acid dosing system 42 via which acid solution can be introduced into at least the product output treatment vessel 40.

Acidification of the product output solution will create an alternative potassium salt in lieu of potassium bicarbonate, whilst also generating carbon dioxide and water. The acid solution used will dictate the potassium salt created, and therefore careful selection of the acid used will potentially result in improved fertilization or fertigation products. For instance, whilst hydrochloric acid may be cheap, the resultant products, such as potassium chloride, have less agricultural benefit.

On the other hand, sulphuric acid, nitric acid, and phosphoric acid respectively yield potassium sulphate, potassium nitrate, and potassium phosphate, which collectively cover the key fertilizer components of potassium, nitrogen, and phosphorus. As such, the increased cost of the raw acid ingredients may be readily recovered by the increased value of the fertilization or fertigation products.

To effectively drive off the potassium bicarbonate, it is preferred that a pH in the range of 1 to 5, and more preferably in the range of 2 to 4, is achieved in the product output treatment vessel 40.

Acidic fertilization or fertigation products are not, however, desirable, and therefore there is also provided a base dosing means 44 for increasing the pH of the acidified product output in the product output treatment vessel 40, preferably to or substantially to between 5.5 and 7. A preferred base used to achieve this is potassium hydroxide, to avoid any sodium contamination of the product output. Sodium hydroxide may still be feasible, however.

The resultant product output in the product output treatment vessel 40 is therefore a liquid fertilization or fertigation product which can be, if desired, directly metered from the product output treatment vessel 40 via a dispenser.

However, a further product output vessel 46 may be provided which collects the second fraction of regenerant. This mixture of potassium nitrate and potassium chloride also has agricultural value, and therefore not only can the first fraction create a fertilization or fertigation product, but the second fraction can create a separate, equally useful and commercially viable, fertilization and/or fertigation product.

In either case, the potassium sulphate and/or bicarbonate product, and the potassium nitrate and chloride product, are both much more concentrated than would be required to act as, in particular, a fertigator. It is expected that dilution of the order of 1:1000 is likely to be realistic in each instance.

The ability to meter, and therefore charge for, fertigation product directly from a water treatment plant may improve the cost-effectiveness thereof to such a level as to permit water treatment in places where it would be otherwise economically unviable. This is particularly important in poor agricultural communities, the potential to re-use the fertigation products locally will encourage both nitrate treatment of the drinking water and improved agricultural practices.

There are additional mechanisms by which the liquid fertilization or fertigation product can be improved.

Firstly, a liquid fertilization or fertigation product is preferred which has no unwanted contaminants. There are some contaminants which may be desirable, such as molybdenum; however, other contaminants are to be actively discouraged from entering the agricultural process. Arsenic is chief among these contaminants.

Arsenic in the As(v) oxidation state is known to break through after nitrate on strong base anion resins, but breaks through before nitrate on nitrate-selective ion exchange resins. This means that traditionally, strong base anion resins have been preferred to nitrate-selective ion exchange resins if the removal of both nitrate and arsenic is required.

However, the introduction of a low level of chloride ions into a loaded strong base anion resin will cause some arsenic to be released from the resin, which in the present invention, will result in elution of arsenic with the potassium sulphate product. This is theorised as being caused by the chloride ions locally reducing the oxidation potential and/or pH around the active functional groups on the anion exchange resin, thereby reducing As(v) to As(iii). As(iii) is not retained on the strong base anion resin, and is therefore eluted.

To avoid this effect, the regenerant can be treated to increase the pH, for example, using the base dosing system 44, to thereby dissuade the reduction of As(v) to As(iii). This allows the As(v) to be retained on the resin during the regeneration. A pH of between 8 and 10, and more preferably a pH of 8.0 to 9.0, will be sufficient to inhibit the reduction of As(v) during the regeneration process.

There may be other ions which may be desirable for agriculture which are not present in sufficient concentrations in the raw water, particularly for cationic species. As such, it may therefore be desirable to attempt to dope the liquid fertilization or fertigation product.

This can be achieved as part of the water purification process. The water purification plant 10, preferably as part of the ion exchange module 12, may further include a cation exchange column 48 which is adapted for cation removal.

Best practice anion exchange plants use softened water for chemical make-up to avoid the risk of insoluble carbonate and sulphate precipitates from forming during the regeneration of the anion resin bed. The cation exchange column 48 is readily used for generating softened water, and may feed directly into the softened water reservoir 30. The cations removed are primarily calcium and magnesium. These cations are therefore removed from the raw water, and by extension, from the product output.

As with anion exchange, the cation exchange column 48 must be regenerated over time as it becomes loaded with cationic species. A regenerant is provided, preferably a potassium chloride regenerant, which flushes the calcium and magnesium from the cation exchange column 48 to generate a calmag output solution comprising calcium and/or magnesium.

To attempt to reduce the waste produced by the present invention the potassium chloride solution is preferably that which is eluted from the strong potassium chloride regeneration of the anion exchange resins 14a, 14b which comprises a mixture of potassium chloride and potassium nitrate. In particular, it is the final portion of the anion ion exchange regenerant which is passed through the cation exchange column 48, followed by a softened water rinse. The reason for this is that strong potassium chloride solution with negligible potassium sulphate is then recycled, mitigating the risk of calcium sulphate or magnesium sulphate being produced and precipitating out into the system. This also has the advantage of regenerating the cation exchange column 48 every time an anion exchange resin 14a, 14b is regenerated, thereby adding controlled levels of calcium and/or magnesium into the product output or further product output.

This produces a calmag output solution, which can be stored in a dedicated further output vessel 46, and which is also suitable for use as a fertilization or fertigation product, either alone, or combined with the product output.

It is noted that in many instances raw water is unlikely to carry sufficient calcium and magnesium to produce appreciable levels for fertilizer in the calmag output solution, and therefore the cation exchange column 48 can be pre-loaded with additional calcium and/or magnesium in order to provide a correct concentration of calcium and/or magnesium for the liquid fertilization or fertigation product. This can be determined by the user of the water treatment plant 10 based on measurements of the raw water.

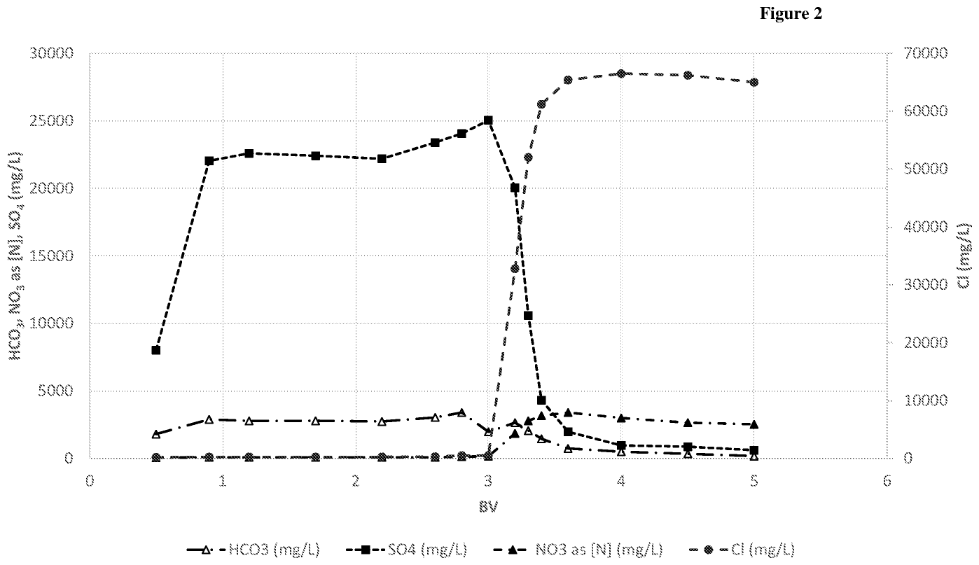

An exemplary embodiment of a water treatment method is hereafter described, with reference to FIGS. 2 to 5.

### EXAMPLE 1

Raw water is passed through an anion exchange column containing a strong base anion resin until nitrate loading is complete. A first fraction of the regenerant, comprising 0.3M potassium chloride, treated to a pH of 8.5, is then passed through the anion exchange column. 3 bed volumes are passed through, at a rate of 2 bed volumes per hour. A second fraction, comprising 2.5M potassium chloride treated to a pH of 8.5, is then passed through the anion exchange column. 2.5 bed volumes are passed through, at a rate of 2 bed volumes per hour.

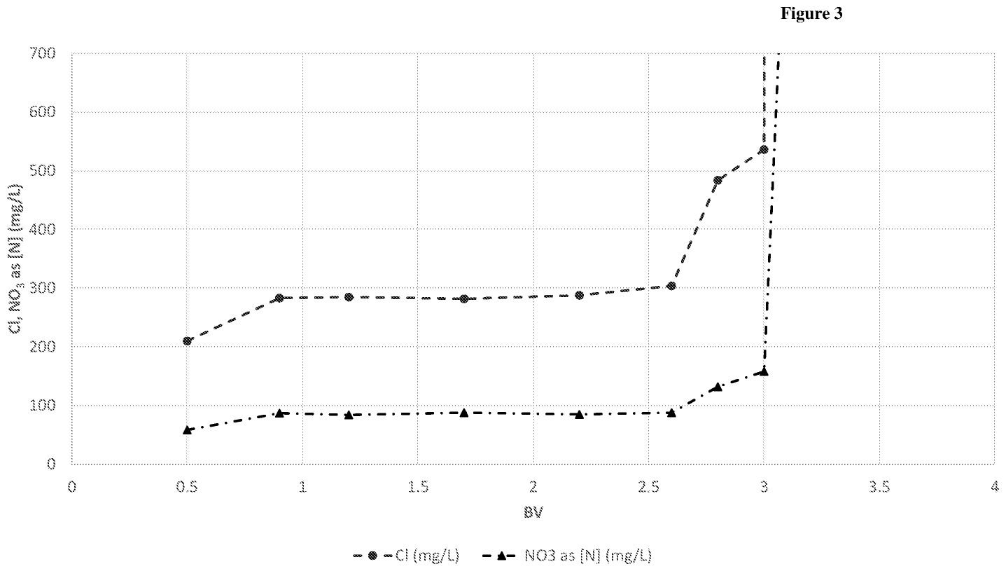

The conductivity and selected ion concentrations are then measured, as indicated in FIGS. 2 and 3, with FIG. 3 showing an expansion of the y-axis of FIG. 2.

As the first fraction is passed through, some potassium salts are eluted from the anion exchange resin. Significant amounts of potassium sulphate and lower quantities of potassium bicarbonate are eluted, as shown in FIG. 2, but with negligible potassium nitrate or potassium chloride elution, as best illustrated in FIG. 3.

The elution, after the first fraction is passed, primarily comprises potassium chloride and potassium nitrate, and this can be collected, the first potassium chloride solution having been tailored to remove all of the sulphate.

The second fraction is passed after the first fraction is complete. The more concentrated potassium chloride solution has a much greater effect on the loaded nitrates, and the concentration of potassium nitrate in the elution rises rapidly. As the nitrate is removed from the anion exchange resin, more potassium chloride is detected in the elution. As discussed above, this elution can also be utilized.

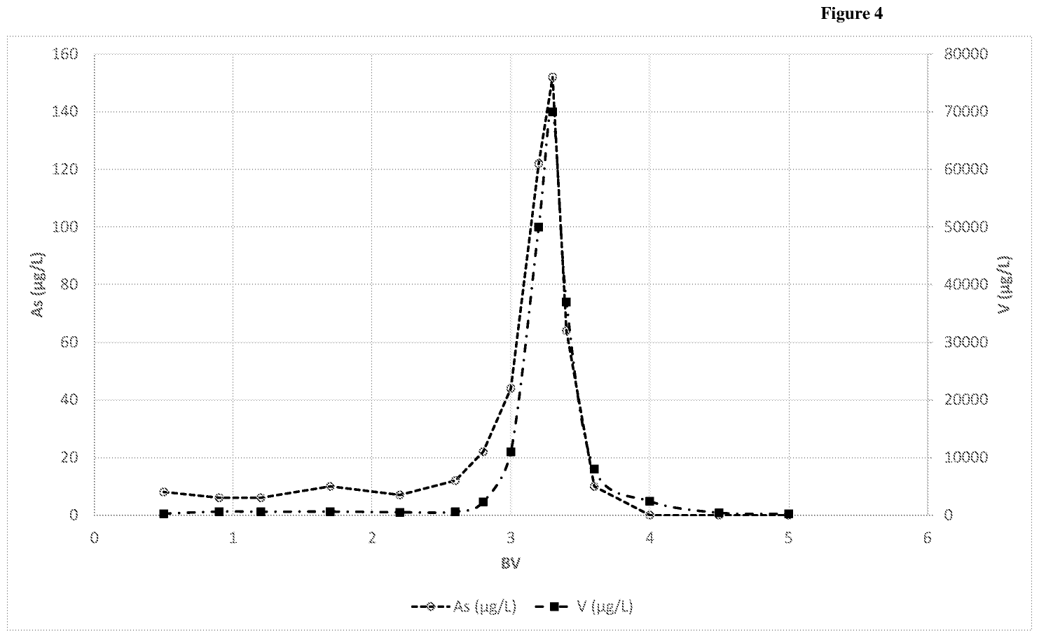

FIG. 4 identifies the effect the regeneration can have on microcontaminants. However, the elution of arsenic has been prevented throughout the regeneration sequence. As discussed above, the increased pH of the regenerant is theorized as causing the prevention of arsenic elution.

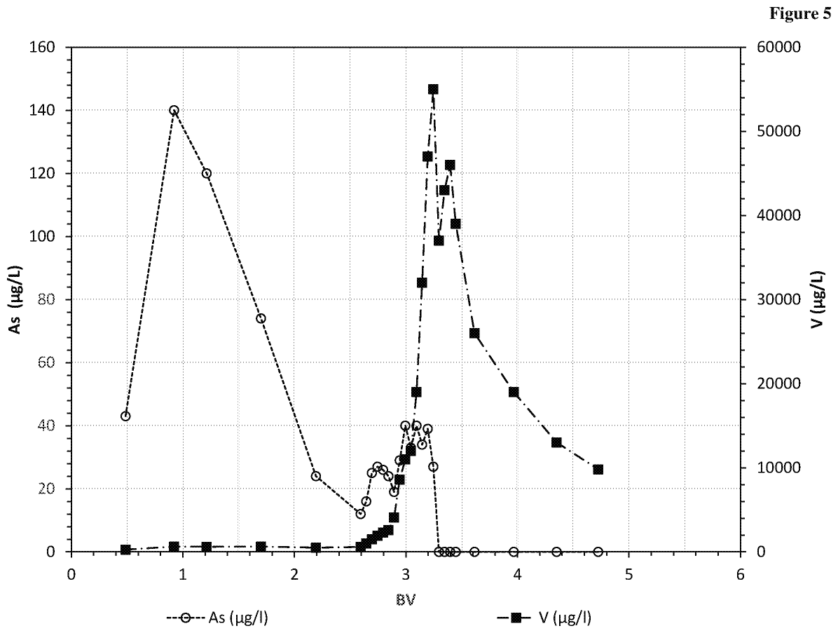

This can be seen in FIG. 5, where an equivalent regeneration has been performed in which no pH treatment has been conducted. There is significant arsenic elution following the passage of the first regenerant fraction through the anion exchange column, which would otherwise have passed into the fertilization or fertigation product.

It will also be apparent that the pH modification has an effect on the vanadium elution. In FIG. 4, where pH treatment has occurred, a sharp elution peak can be seen for vanadium, in which vanadium is removed between 3.0 and 3.5 bed volumes. However, in FIG. 5, where no pH treatment is provided, a longer elution tail is present. This is caused by the same local reduction in the Eh or pH at the functional sites on the resin to which the vanadium is bound. This results in a reduction of the oxidation state of the vanadium to V(iii), where it forms a gelatinous precipitate. This precipitate slowly dissolves as the regeneration proceeds.

With the pH treatment, it is clear that an option is availed to isolate, where required, many of the oxyanions which may be present in the raw water, including but not limited to the arsenic and vanadium, as well as other contaminants such as molybdenum and selenium, for either separate disposal or treatment. For benign microcontaminants, it is preferred that this is included in the further product stream of the potassium chloride and potassium nitrate, if the levels are below maximum limits for fertilizer products.

Using the above-described method, it is therefore possible to use water purification processes to produce fertilization or fertigation products which are suitable for agricultural use.

Whilst acid treatment of the potassium bicarbonate in the product output is described above, this is not the only possible means by which the potassium sulphate and bicarbonate could be separated.

After a regeneration operation is completed, the regenerated column is returned to service, flowing raw water and removing nitrate. Initially, as the resin is fully loaded with chloride after a regeneration, all the major anions are removed from the water passing through the column, to be replaced by chloride. As such, the product water will be high in chloride and low in bicarbonate, which is more corrosive to the water distribution system.

This is mitigated by blending the column outlet with the second column, and with the untreated water flowing through the plant bypass 24, but, if the raw water itself tends to be corrosive, the may still be a risk to the water distribution system. This is primarily a risk for nitrate-selective resins, which are typically chosen in preference to strong base anion resins

To reduce this corrosivity issue, rather than using chemical additions to convert bicarbonate to sulphate, the potassium sulphate-bicarbonate mixture can be treated by using a filter, preferably a loose nanofiltration membrane. This will produce a reject stream of potassium sulphate with a permeate consisting of a bicarbonate solution with lower levels of sulphate. This configuration is unlikely to be suitable with a strong base anion resin, since the concentration of sulphate would likely become too high and would crystallise out onto the nanofiltration membrane.

The reject stream would the become the product potassium sulphate solution whereas the permeate would be passed through the ion exchange column at the end of the regeneration process as a conditioning step. At the concentrations in the permeate, both the bicarbonate and sulphate would be re-absorbed onto the resin, being replaced by the chloride.

Whilst the calmag product output is described as containing a mixture of potassium nitrate and potassium chloride in addition to any cationic additions of calcium and magnesium, there may be advantages in attempting to remove the potassium chloride. Options for separating the nitrate and chloride from the solution include: eutectic freeze crystallization; evaporation; and assisted evaporation. These methods utilise different physical characteristics of the chloride and nitrate salts to ensure that they can be separated, allowing for nitrate to be selectively removed and used as a fertilizer, whilst the potassium chloride may then be recycled in future regenerants.

Complementary compounds could also be considered as additives to either the product output, that is, the potassium sulphate and/or bicarbonate, or the further product output, that is the potassium nitrate and chloride, which then result in complete fertigation or fertilization products. For instance, additional nitrogen and phosphorus, in the form of ammonium nitrate, urea, mono-ammonium phosphate or di-ammonium phosphate, could all be considered as additives. Trace elements could also be inserted, possibly immediately prior to dispensing.

It is therefore possible to provide a method and plant which is capable of not only purifying raw water, primarily by the removal of nitrate components therein, to produce potable water, but also to reduce the waste output by ensuring that the different regenerant elutions from the ion exchange columns are utilized. This can be achieved by processing the elutions to extract agriculturally useful products, which can then be provided as fertilizer or fertigation products.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A water treatment method to generate potable water and a fertilization or fertigation product, the water treatment method comprising the steps of:
a] passing a raw water stream through an anion exchange resin having a defined bed volume to generate a potable water output; and
b] regenerating the anion exchange resin using by passing a weak potassium chloride solution through the anion exchange resin to generate a product output comprising potassium sulphate and potassium bicarbonate, wherein the product output is useful as a precursor for a liquid fertilization or fertigation product.

2. The method of claim 1, wherein, in step b], the weak potassium chloride solution is a 0.02M to 0.5M potassium chloride solution and from 3 to 6 bed volumes of the potassium chloride solution is passed through the anion exchange resin at a flow rate of 1 to 4 bed volumes per hour.

3. (canceled)

4. The method of claim 1, wherein in step b], the product output further comprises potassium nitrate.

5. The method of claim 1, further comprising a step b](i) subsequent to step b] of: further regenerating the anion exchange resin by passing a strong potassium chloride solution through the anion exchange resin to generate a further product output comprising potassium nitrate and potassium chloride.

6. The method of claim 5, wherein, in step b](i), the strong potassium chloride solution is a 1.5M to 3.0M potassium chloride solution and from 3 to 6 bed volumes of the potassium chloride solution is passed through the anion exchange resin at a flow rate of 1 to 4 bed volumes per hour.

7. (canceled)

8. The method of claim 5, further comprising a step b](ii) subsequent to step b](i) of separating the potassium nitrate from the potassium chloride generated in step b](i).

9. The method of claim 5, wherein the separation of the potassium nitrate and potassium chloride in step b](ii) is achieved by any one of or a combination of processes selected from the group consisting of: eutectic freeze crystallization; evaporation; and vacuum-assisted evaporation.

10. The method of claim 8, further comprising a step b](iii), subsequent to step b](ii) of rinsing the anion exchange resin by passing softened water at a flow rate of 1 to 4 bed volumes per hour through the anion exchange resin.

11. The method of claim 1, further comprising the step of: c] combining the product output from step b] with an acid in a treatment vessel to reduce the pH of the product output to between 2 and 4 to remove the potassium bicarbonate, wherein the acid is selected from the group consisting of sulphuric acid, nitric acid, and phosphoric acid, to respectively convert the potassium bicarbonate to a potassium salt selected from the group consisting of potassium sulphate, potassium nitrate, or potassium phosphate.

12. (canceled)

13. The method of claim 11, further comprising the step of: d] combining the product output from step c] with a base in the treatment vessel to increase the pH of the product output to about 5.5 to about 7, to produce a liquid fertilization or fertigation product comprising potassium sulphate and a salt of the acid used, wherein the base is potassium hydroxide.

14. (canceled)

15. The method of claim 1, wherein, in step b], a base is added to the weak potassium chloride solution to increase the pH to between 8 and 10, to inhibit the elution of any arsenic present in the As(III) oxidation state in the raw water stream.

16. The method as claimed in any one of the preceding claims of claim 1, wherein, the anion exchange resin system of step a] is selected from the group consisting of a lead-lag anion exchange resin system and a merry-go-round anion exchange resin system; and a nitrate-selective anion exchange resin or a strong base anion resin.

17. (canceled)

18. The method of claim 13, wherein, in step a], the raw water stream and/or potable water output is passed through a cation exchange column to remove calcium and/or magnesium.

19. The method of claim 18 further comprising a step a](i), subsequent to step a] of regenerating the cation exchange column to generate a calmag output solution comprising calcium and/or magnesium, and, in step d], introducing at least a portion of the calmag output solution into the liquid fertilization or fertigation product.

20. (canceled)

21. The method of claim 19, wherein, in step a](i), the cation exchange column is regenerated using a solution of the potassium chloride separated subsequent to step b] according to the substeps: b](i) further regenerating the anion exchange by passing a strong potassium chloride solution through the anion exchange resin to generate a further product output comprising potassium nitrate and potassium chloride followed by b](ii) separating the potassium nitrate from the potassium chloride generated in step b](i).

22. The method of claim 19, wherein, prior to step a], the cation exchange column is pre-loaded with calcium and/or magnesium to provide a correct concentration of calcium and/or magnesium for the liquid fertilization or fertigation product.

23. The method of claim 18, further comprising the step of separating the output of the cation exchange column into a high chloride stream and a low chloride stream via reverse osmosis.

24. The method of claim 1, further comprising at least one of the following steps subsequent to step b] selected from the group consisting of: a step of filtering the product output using a nanofilter to separate the potassium bicarbonate and potassium sulphate; subsequent to filtering the product output using a nanofilter, a step of generating a fungicide product using the potassium bicarbonate product output; and/or the step of adding complementary fertilization compounds to the product output to produce a desired fertilization or fertigation product.

25. (canceled)

26. (canceled)

27. A water treatment plant comprising: a raw water input; at least one anion exchange resin having an inlet and an outlet, the raw water input being in fluid communication with the inlet of the or each anion exchange resin; a regenerant line in fluid communication with the inlet of the or each anion exchange resin; a potable water conduit in fluid communication with the outlet of the or each anion exchange resin; a product output treatment vessel in fluid communication with the outlet of the or each anion exchange resin to receive the output of a first ion-exchange regeneration effluent; a further output vessel in fluid communication with the outlet of the or each anion exchange resin to receive the output of a second ion-exchange regeneration effluent; a controller to selectively control the fluid flow from the outlet of the or each anion exchange resin; and a dispenser associated with the product output treatment vessel to dispense a liquid fertilization or fertigation product generated therein.

28. The A-water treatment plant of claim 27, further comprising a cation exchange column having an inlet and an outlet, the inlet being in fluid communication with at least one of the raw water input and the potable water conduit, and the outlet being in communication with at least one of the product output treatment vessel and the further output vessel.
